(19) United States
(12) Patent Application Publication
(10) Pub. No.: US 2008/0264545 A1
(43) Pub. Date: Oct. 30, 2008

(54) Method of Production of an Electronic Device Having Internal Electrode

(76) Inventors: Shigeki Sato, Narita (JP); Shogo Murosawa, Nikaho (JP); Tsuneo Suzuki, Chiba (JP)

Correspondence Address: OLIFF & BERRIDGE, PLC, P.O. BOX 320850, ALEXANDRIA, VA, 22320-4850, US

(21) Appl. No.: 11/920,963

(22) PCT Filed: May 26, 2005
(86) PCT No.: PCT/JP2005/009678

§ 371 Date: Feb. 7, 2008

(51) Int. Cl. B29C 65/02

(52) U.S. Cl. 156/89.12; 156/538

(57) ABSTRACT

When transferring an adhesion layer 28 to an electrode layer 12a, carrier sheets 20 and 26 are fed between first and second transfer rolls 40 and 42 so that a rear surface of a first carrier sheet 20, in which the electrode layer is formed, makes contact with a first transfer roll 40 and a rear surface of a second carrier sheet 26, in which adhesion layer 28 is formed, makes contact with a second transfer roll 42; and a first transfer roll 40 is heated at a first predetermined temperature T1 (° C.), a second transfer roll 42 is heated at a second predetermined temperature T2 (° C.), in which a first predetermined temperature T1 and a second predetermined temperature T2 satisfy 60<T1<110, preferably 80≦T1≦100; 90≦T2≦135, preferably 100≦T2<120; and 190<T1+T2, preferably 195≦T1+T2≦220.

### TECHNICAL FIELD

The present invention relates to a method of production of an electronic device having an internal electrode.

### BACKGROUND ART

Recently, an electronic device loaded into an electronic system becomes more reduced in size and higher in performance as a variety of electronic devices are downsized. A multilayer ceramic capacitor is one of electronic components, and required to be downsized and improved in performance.

In order to promote downsizing and improving in performance of the multilayer ceramic capacitor, it is strongly required to make a dielectric layer thinner. Recently, a thickness of a dielectric green sheet is reduced to several micrometers or less.

When producing a ceramic green sheet, it is usual to prepare a ceramic paste comprised of ceramic powders, a binder (acrylic resin, butyral-based resin, etc.), a plasticizer, and an organic solvent (toluene, alcohol, MEK, etc.) at first. Then, the ceramic paint is applied on a carrier sheet such as PET by using doctor blade method, etc., and heated to dry, so that the ceramic green sheet is produced.

Recently, it is also studied to produce a ceramic green sheet by preparing a ceramic suspension comprised of ceramic powders and a binder mixed in a solvent, and biaxial drawing a film-like article obtained by extrusion molding of the suspension.

To specifically explain a method to produce a multilayer ceramic capacitor by using the above-mentioned ceramic green sheet, an internal electrode conductive paste including metal powders and a binder is printed in a predetermined pattern on the ceramic green sheet, and dried to form an internal electrode pattern. Then, the carrier sheet is removed from said ceramic green sheet. A plurality of the carried sheets is stacked to cut in a chip form, so that a green chip is obtained. After firing the green chip, an external electrode is formed to produce the multilayer ceramic capacitor.

However, when printing an internal electrode paste on a very thin ceramic green sheet, there is a defect that a solvent in an internal electrode paste dissolves or swells the binder component in the ceramic green sheet. Also, there is another defect that an internal electrode paste leaks in the green sheet. These defects may often cause short circuit failure.

To resolve these defects, in Patent Articles 1-3 (The Japanese Unexamined Patent Publication S63-51616, The Japanese Unexamined Patent Publication H3-250612, The Japanese Unexamined Patent Publication H7-312326), an internal electrode pattern is formed on a support sheet and then dried to prepare an additional electrode pattern in dry type. The patent articles propose an internal electrode pattern transfer method wherein this dry type electrode pattern is transferred on a surface of each ceramic green sheet or a surface of a multilayer body of ceramic green sheets.

However, the arts described in these Patent Articles 1 and 2, in which an electrode pattern is formed by printing on the support film, and heat-transferred, have a problem that it is difficult to remove the electrode pattern from a support film.

Also, considering peeling property and transferability of the ceramic green sheet in stacking step, a parting agent is usually added to a dielectric paste constituting the green sheet, or is coated on a support sheet on which the green sheet is formed. Therefore, when the ceramic green sheet is especially thin, the ceramic green sheet on the support sheet is very weak in strength and easy to be broken down. Alternatively, the ceramic green sheet on the support sheet is easily displaced. Therefore, it is very difficult to transfer a dry type electrode pattern on the surface of the green sheet with a high degree of accuracy, so that the ceramic green sheet may be partially broken down during the transfer step.

Furthermore, in the art described in Patent Article 3, when forming a release layer on a support sheet on which a dry type electrode pattern is formed, an electrode pattern forming layer and a layer for preventing from transferring the electrode pattern to the back side of the supporting sheet, etc., are formed to prevent eye hole of an electrode pattern, etc. This method is expected to make it easier to transfer an electrode pattern on the surface of the green sheet, but is not satisfactory and has a problem to increase the production cost of the support sheet.

Also, the transfer methods according to these prior arts require high pressure and heat to transfer an electrode pattern layer to the surface of green sheet. Therefore, the green sheet, the electrode layer and the support sheet are easily deformed, sometimes resulting in an unpracticed stacked body or short circuit failure due to breakage of the green sheet.

Furthermore, when the adhering green sheet and the electrode layer, it is difficult to selectively remove either one of two respective support sheets to support each of them.

Note that an adhesion layer can be formed on the surface of the electrode layer or green sheet to make it easy to transfer the electrode layer. However, when directly forming the adhesion layer on the surface of the electrode layer or green sheet by a coating method, etc., a constituent of the adhesion layer is leaked in the electrode layer or green sheet. Therefore, the adhesion layer may hardly fulfill its functions, and also give some bad influences on the composition of the electrode layer or green sheet.

Consequently, to resolve the above-described problems, the present inventors filed an application (PCT: WO2004/061880A1), proposing to form an adhesion layer on the surface of an electrode layer by a transfer method. According to the method, it is possible to make a thickness of the adhesion layer thinner by forming it on the surface of the electrode layer or green sheet by the transfer method, and also to prevent a constituent of the adhesion layer from leaking in the electrode layer or green sheet.

However, it was found that it is not always easy to transfer the adhesion layer when producing in large quantities while this is fine for an experimental level of production. For example, when using a pair of transfer rolls to transfer the adhesion layer, there may be problems that the sheet gets wrinkles to make it hard to be stacked, or adhesion strength becomes insufficient in the adhesion layer to well transfer. The present inventors found a transfer method of an adhesion layer more suitable for mass production as a result of further experiments, and completed the present invention based on the findings.

### DISCLOSURE OF INVENTION

### Problem to be Solved by the Invention

An object of the present invention, completed reflecting such a situation, is to provide a method of production of an electronic device having an internal electrode, capable to give an adhesion layer to be transferred wherein sheets without wrinkles are easy to be stacked and an adhesion strength is sufficient, and to transfer the adhesion layer favorably, which is therefore suitable for stacking more layers and making layers thinner.

### Means for Solving the Problem

To attain the above purpose, according to an aspect 1-1 of the present invention, a method of production of an electronic device having an internal electrode comprises steps of:

forming an electrode layer on a surface of a first support sheet;

forming an adhesion layer on a surface of a second support sheet;

forming said adhesion layer on a surface of said electrode layer by a transfer method;

pressing a green sheet to the surface of said electrode layer via said adhesion layer to adhere said electrode layer to a surface of said green sheet;

stacking green sheets, to which said electrode layer is adhered, to form a green chip; and

firing said green chip;

wherein, when transferring said adhesion layer to said electrode layer,

said first support sheet and said second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll; and

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80≦T1≦100,
90≦T2<135, preferably 100≦T2≦120, and
190<T1+T2, preferably 195≦T1+T2≦220.

According to an aspect 1-2 of the present invention, a method of production of an electronic device having an internal electrode comprises steps of:

forming an adhesion layer on a surface of an electrode layer formed on a surface of a first support sheet;

forming a green sheet on a surface of a second support sheet;

pressing the green sheet, formed on the surface of said second support sheet, to the surface of said electrode layer via said adhesion layer to adhere said green sheet to the surface of said electrode layer by transfer method;

stacking green sheets, to which said electrode layer is adhered, to form a green chip; and

firing said green chip;

wherein, when transferring said green sheet to said electrode layer,

said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll; and

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80≦T1≦100,
90≦T2<135, preferably 100≦T2≦120, and
190<T1+T2, preferably 195≦T1+T2≦220.

According to an aspect 1-3 of the present invention, a method of production of an electronic device having an internal electrode comprises steps of:

forming a green sheet on a surface of an electrode layer formed on a surface of a first support sheet;

forming an adhesion layer on a surface of a second support sheet;

pressing the adhesion layer, formed on the surface of said second support sheet, to the surface of said green sheet to transfer said adhesion layer to the surface of said green sheet by transfer method;

stacking green sheets, on which said internal electrode layer is formed, to form a green chip; and

firing said green chip;

wherein, when transferring said adhesion layer to said green sheet,

said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll; and

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80≦T1≦100,
90≦T2<135, preferably 100≦T2≦120, and
190<T1+T2, preferably 195≦T1+T2≦220.

In the method of production according to the present invention, when transferring an adhesion layer to an electrode layer (alternatively, to a green sheet; hereinafter same as above), or when transferring a green sheet to an electrode layer, a support sheet is fed between a first and second transfer rolls, and these rolls are heated at predetermined temperatures. By controlling a temperature of the roll so as to satisfy the above temperature conditions at this time, it is possible to obtain the adhesion layer having sufficient adhesion strength without wrinkles in the sheet and to transfer the adhesion layer favorably. As a result, it is possible to stack the sheets favorably and to produce an electronic device having an internal electrode suitable for stacking more layers and making layers thinner.

In the method of production according to the present invention, an adhesion layer is formed on a surface of an electrode layer by a transfer method, and a green sheet is adhered to the surface of the electrode layer via the adhesion layer. By forming the adhesion layer, high pressure and heat are not required when adhering to transfer the green sheet to the surface of the electrode layer, so that it is possible to adhere the green sheet at low pressure and temperature. Therefore, even when the green sheet is very thin, the green sheet having the internal electrode can be well stacked without breakage, and no short circuit failure, etc., is caused.

Furthermore, according to the present invention, an adhesion layer is formed on a surface of an electrode layer or green sheet by a transfer method, instead of directly forming by a coating method, etc., so that a constituent of the adhesion layer is not leaked in the electrode layer or green sheet. Also, it allows forming a very thin adhesion layer. For example, a thickness of the adhesion layer can be 0.02 to 0.3 μm or so. Even if the thickness of the adhesion layer is thin, no constituent of the adhesion layer is leaked in the electrode layer or green sheet, so that an adhesion force is sufficient and a composition of the electrode layer or green sheet is secure from bad influence.

Preferably, the thickness of the adhesion layer is 0.02˜0.3 μm. When the thickness of the adhesion layer is too thin, the thickness of the adhesion layer becomes smaller than concavity and convexity of the surface of the green sheet, so that adhesiveness tend to be significantly lowered. On the other hand, when the thickness of the adhesion layer is too thick, spaces may be easily caused inside a fired element body depending on the thickness of the adhesion layer, so that capacitance is liable to be significantly reduced based on a reduced volume due to the spaces.

According to an aspect 2-1 of the present invention, a method of production of an electronic device having an internal electrode comprises steps of:

forming an electrode layer on a surface of a first support sheet;

forming an adhesion layer on a surface of a second support sheet;

pressing a green sheet to the surface of said electrode layer via said adhesion layer to adhere said electrode layer to a surface of said green sheet;

stacking green sheets, to which said electrode layer is adhered, to form a green chip; and

firing said green chip;

wherein, when transferring said adhesion layer to said electrode layer,

said first support sheet and second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll;

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80≦T1≦100,
80≦T2<135, preferably 80≦T2≦100 and
170<T1+T2, preferably 180≦T1+T2≦200; and,

said first support sheet and second support sheet are preliminarily heated at a temperature of 80° C. or higher, preferably at a temperature of 80 to 100° C., respectively before said first support sheet and second support sheet are fed between said first and second transfer rolls.

According to an aspect 2-2 of the present invention, a method of production of an electronic device having an internal electrode comprises steps of:

forming an adhesion layer on a surface of an electrode layer formed on a surface of a first support sheet;

forming a green sheet on a surface of a second support sheet;

pressing the green sheet, formed on the surface of said second support sheet, to the surface of said electrode layer via said adhesion layer to adhere said green sheet to the surface of said electrode layer by transfer method;

stacking green sheets, to which said electrode layer is adhered, to form a green chip; and

firing said green chip;

wherein, when transferring said green sheet to said electrode layer,

said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll;

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80≦T1≦100,
80≦T2<135, preferably 80≦T2≦100 and
170<T1+T2, preferably 180≦T1+T2≦200; and

said first support sheet and second support sheet are preliminarily heated at a temperature of 80° C. or higher, preferably at a temperature of 80 to 100° C., respectively before said first support sheet and second support sheet are fed between said first and second transfer rolls.

According to an aspect 2-3 of the present invention, a method of production of an electronic device having an internal electrode comprises steps of:

forming a green sheet on a surface of an electrode layer formed on a surface of a first support sheet;

forming an adhesion layer on a surface of a second support sheet;

pressing said adhesion layer to the surface of said green sheet to transfer said adhesion layer to the surface of said green sheet;

stacking green sheets, to which said electrode layer is adhered, to form a green chip; and

firing said green chip;

wherein, when transferring said adhesion layer to said green sheet,

said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll;

said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110, preferably 80<T1<100,
80≦T2<135, preferably 80<T2≦100 and
170<T1+T2, preferably 180≦T1+T2≦200; and

said first support sheet and second support sheet are preliminarily heated at a temperature of 80° C. or higher, preferably 80 to 100° C., respectively before said first support sheet and second support sheet are fed between said first and second transfer rolls.

According to the second aspect of the present invention, in addition to effects in the above-mentioned first aspect of the present invention, the following effects are shown. Namely, in the second aspect of the present invention, it is possible to lower a temperature for heating a transfer roll and to increase a feeding rate (transfer rate) of a support sheet between a pair of the transfer rolls, compared with the first aspect. Namely, even when the feeding rate (transfer rate) of the support sheet between a pair of the transfer rolls is increased four times for instance, it is possible to well transfer an adhesion layer (or green sheet) without wrinkles in the sheet and with a sufficient adhesion strength. Without preliminarily heating (in the first aspect of the present invention), increase in the transfer rate makes a favorable transfer difficult. On the other hand, in the second aspect of the present invention, a favorable transfer is possible even when increasing the transfer rate.

In the first aspect and second aspect of the present invention, it is preferable that: T1≦T2. Depending on conditions, a favorable transfer is possible even in the case of T1>T2, but the range of the conditions are narrow, compared to the case of T1≦T2 having broader range of condition for a favorable transfer.

According to an aspect 3-1 of the present invention, a method of production of an electronic device having an internal electrode comprises steps of:

forming an electrode layer on a surface of a first support sheet;

forming an adhesion layer on a surface of a second support sheet;

forming said adhesion layer on a surface of said electrode layer by a transfer method;

pressing a green sheet to the surface of said electrode layer via said adhesion layer to adhere said electrode layer to a surface of said green sheet;

stacking green sheets, to which said electrode layer is adhered, to form a green chip; and

firing said green chip;

wherein

said first support sheet and second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll; and

any one of said first and second transfer rolls is heated while the other is not heated, in which the support sheet to be making contact with the other not-heated transfer roll is preliminarily heated at a temperature of 80° C. or higher before making contact with the transfer roll.

According to an aspect 3-2 of the present invention, a method of production of an electronic device having an internal electrode comprises steps of:

forming an adhesion layer on a surface of an electrode layer formed on a surface of a first support sheet;

forming a green sheet on a surface of a second support sheet;

pressing the green sheet, formed on the surface of said second support sheet, to the surface of said electrode layer via said adhesion layer to adhere said green sheet to the surface of said electrode layer by transfer method;

stacking green sheets, to which said electrode layer is adhered, to form a green chip; and

firing said green chip;

wherein, when transferring said green sheet to said electrode layer,

said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll; and

any one of said first and second transfer rolls is heated while the other is not heated, in which the support sheet to be making contact with the other not-heated transfer roll is preliminarily heated at a temperature of 80° C. or higher before making contact with the transfer roll.

According to an aspect 3-3 of the present invention, a method of production of an electronic device having an internal electrode comprises steps of:

forming a green sheet on a surface of an electrode layer formed on a surface of a first support sheet; forming an adhesion layer on a surface of a second support sheet;

pressing said adhesion layer to the surface of said green sheet to transfer said adhesion layer to the surface of said green sheet;

stacking green sheets, to which said electrode layer is adhered, to form a green chip; and

firing said green chip;

wherein, when transferring said adhesion layer to said green sheet,

said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll; and

any one of said first and second transfer rolls is heated while the other is not heated, in which the support sheet to be making contact with the other not-heated transfer roll is preliminarily heated at a temperature of 80° C. or higher before making contact with the transfer roll.

A method of production according to the third aspect of the present invention allows well transferring an adhesion layer (or green sheet) on a surface of an electrode layer (or green sheet). Note that a range of conditions for a favorable transfer is narrow in the third aspect of the present invention, compared to the first and second aspects of the present invention.

In the first and third aspects of the present invention, preferably, a preliminary heating temperature is 135° C. or lower, and more preferably, 100° C. or lower. When the preliminary heating temperature is too high, it is liable that a sheet easily gets wrinkles; when too low, effects of the preliminary heating becomes small.

Preferably, said first support sheet is linearly fed between said first and second transfer rolls; and

said second support sheet is fed between said first and second transfer rolls with a first predetermined angle θ1, and output with a second predetermined angle θ2, with respect to said first support sheet.

Since the electrode layer is formed on the surface of the first support sheet, it is preferred that the first support sheet is linearly fed between a pair of the transfer rolls. This is to prevent the sheet from getting wrinkles.

Note that the adhesion layer (or green sheet), formed on the surface of the second support sheet, is transferred to the surface of the electrode layer on the first support sheet after the second support sheet is passing between the first and second transfer rolls. Therefore, it is preferable that the second support sheet is fed between the first and second transfer rolls with a first predetermined angle θ1 and output with a second predetermined angle θ2, with respect to the first support sheet. This construction allows well transferring the adhesion layer (or green sheet) on the second support sheet to the surface of the electrode layer on the first support sheet.

In the present invention, preferably, said electrode layer is formed on the surface of said first support sheet so as to have a peel strength of 10 to 60 mN/cm;

said adhesion layer is formed on the surface of said second support sheet so as to have a peel strength of 10 mN/cm or lower. This construction allows well transferring the adhesion layer (or green sheet) on the second support sheet to the surface of the electrode layer on the first support sheet.

Preferably, said second transfer roll is comprised of metal, and

said first transfer roll is a roll lined with a rubber layer. This construction allows applying a pressure evenly divided between the rolls, resulting in a favorable transfer.

Preferably, a release layer is formed on the surface of said first support sheet, and

said electrode layer is formed on the release layer.

Preferably, a blank pattern layer having a thickness substantially same as that of said electrode layer is formed on the surface of said release layer on which said electrode layer is not formed. By forming the blank pattern layer, the difference in level in the surface due to the electrode layer in a predetermined pattern is eliminated. Therefore, even if applying a pressure onto a stacked body of many green sheets before firing, the outer surface of the stacked body is kept flatly without displacing the electrode layer in planar direction, and the electrode layer does not penetrate in the green sheet to cause short circuit.

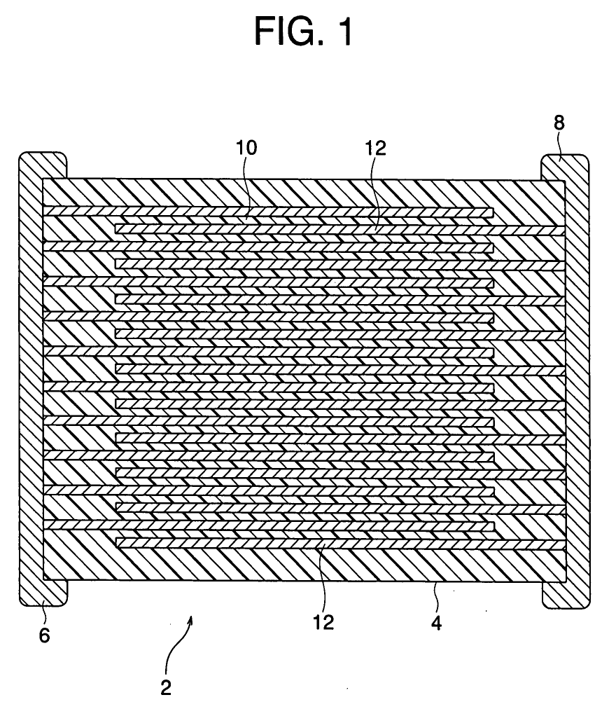

FIG. 1 is a schematic cross-sectional view of a multilayer ceramic capacitor according to an embodiment in the present invention.

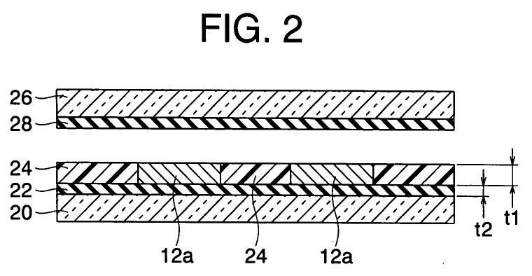

FIG. 2 is a sectional view of a key part of each support sheet before transferring an adhesion layer.

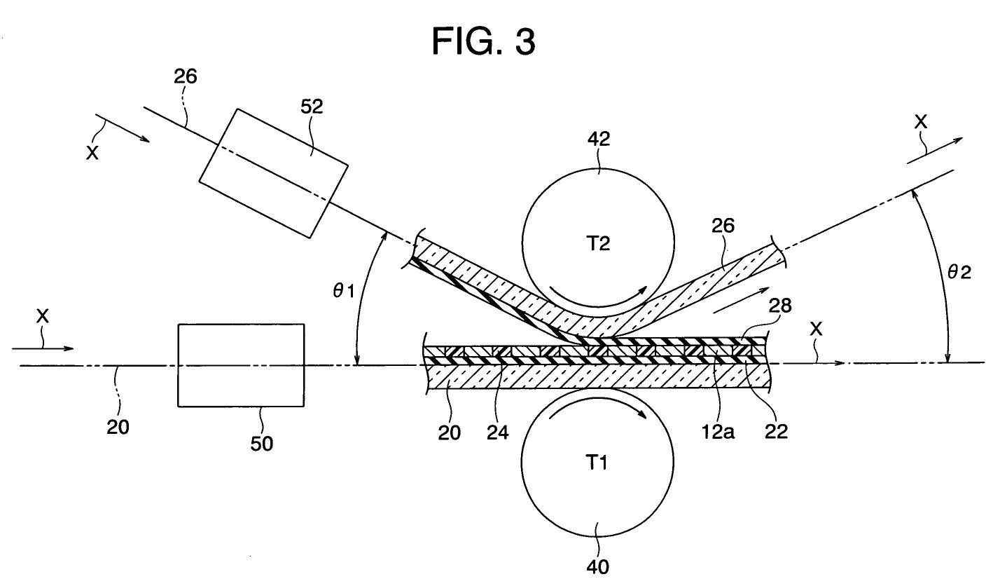

FIG. 3 is a view showing a transfer method of an adhesion layer.

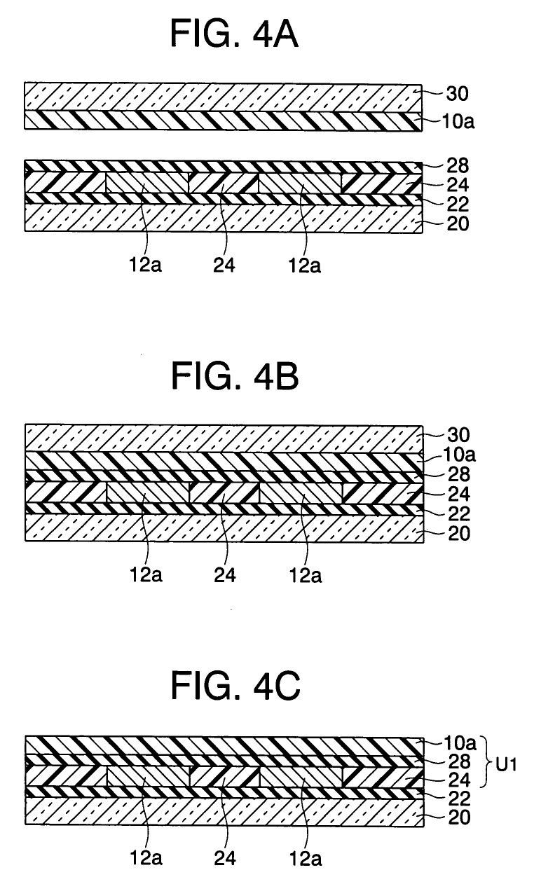

FIG. 4A is a sectional view of a key part showing sequential step after that in FIG. 3; FIG. 4B is a sectional view of a key part showing a sequential step after that in FIG. 4A; and FIG. 4C is a sectional view of a key part showing sequential step after that in FIG. 4B.

### BEST MODE FOR WORKING THE INVENTION

Hereinafter, the present invention will be described based on the embodiment shown in the drawings.

First, an overall structure of a multilayer ceramic capacitor will be described as an embodiment of an electronic device produced by the method according to the present invention.

### First Embodiment

As shown in FIG. 1, a multilayer ceramic capacitor 2 according to the present embodiment comprises a capacitor body 4, a first terminal electrode 6 and a second terminal electrode 8. The capacitor body 4 comprises a dielectric layer 10 and an internal electrode layer 12, wherein the internal electrode 12 layers are alternately stacked between the dielectric layers 10. One of the internal electrode layers 12 alternately stacked is electrically connected with an inside of the first terminal electrode 6 formed outside of a terminal portion of the capacitor body 4. Also, the other internal electrode layer 12 alternately stacked is electrically connected with an inside of the second terminal electrode 8 formed outside the other terminal portion of the capacitor body 4.

In the present embodiment, the internal electrode layer 12 is, as later described in details, formed by transferring a ceramic green sheet 10a to an electrode layer 12a shown in FIG. 4A. Although it is composed of a same material as the electrode layer 12a, the internal electrode layer 12 is thicker than the electrode layer 12a by the size in which has shrunk in the horizontal direction.

A material of the dielectric layer 10 is not particularly limited, and is, for example, composed of a dielectric material such as calcium titanate, strontium titanate and/or barium titanate for example. A thickness of each dielectric layer 10 is not particularly limited, and is normally several micrometers to several hundreds micrometers. Particularly in the present embodiment, the thickness is reduced to preferably 5 μm or less, more preferably 3 μm or less.

A material of the terminal electrodes 6 and 8 is not particularly limited as well, and there is normally used copper, copper alloy, nickel, nickel alloy, etc. Also, silver, an alloy of silver and palladium, etc. can be used. A thickness of the terminal electrodes 6 and 8 is not particularly limited as well, and is normally 10 to 50 μm or so.

A shape and size of the multilayer ceramic capacitor 2 may be properly determined depending on a purpose or application. In the case of the multilayer ceramic capacitor 2 having a rectangular parallelepiped shape, it is usual to have a height of 0.6 to 5.6 mm, preferably 0.6 to 3.2 mm, a width of 0.3 to 5.0 mm, preferably 0.3 to 1.6 mm, and a breadth of 0.1 to 1.9 mm, preferably 0.3 to 1.6 mm, or so.

Next, there will be described an example of methods of production of the multilayer ceramic capacitor 2 according to the present embodiment.

(1) First, a dielectric paste is prepared to produce a ceramic green sheet later-constituting the dielectric layer 10 shown in FIG. 1 after firing. The dielectric paste is normally composed of an organic solvent based paste, obtained by kneading a dielectric material and an organic vehicle, or an aqueous paste.

The dielectric material may be properly selected from a composite oxide and a variety of compounds to become an oxide, such as carbonate, nitrate, hydroxide and organic metal compound, and mixed to use. The dielectric material is normally used in powder form with an average particle size of 0.1 to 3.0 μm. Note that it is preferable to use a powder with a smaller particle size than the thickness of the green sheet to form very thin green sheet.

The organic vehicle is obtained by dissolving a binder in an organic solvent. As a binder used for the organic vehicle, although not particularly limited, there may be used a variety of normal binders such as ethyl cellulose, polyvinyl butyral and acrylic resin. It is preferred to use butyral-based resin such as polyvinyl butyral.

Furthermore, the organic solvent used for the organic vehicle is not particularly limited as well, and may include alcohols such as ethanol and propanol; ketones such as terpineol, butyl carbitol, acetone and MEK; and aromatic compounds such as toluene. Also, the vehicle in the aqueous paste is obtained by dissolving an aqueous binder in water. The aqueous binder is not particularly limited, and there may be used polyvinyl alcohol, methylcellulose, hydroxyethyl cellulose, an aqueous acrylic resin, emulsion, etc. A content of each component in the dielectric paste is not particularly limited, and for example, there may be included about 1 to 5 wt % of the binder and about 10 to 50 wt % of the solvent (or water).

The dielectric paste may include, if needed, additives selected from a variety of dispersants, plasticizers, dielectrics materials, glass frits, insulators, etc. Note that a total content of these additives is desirable to be 10 wt % or smaller. When using a butyral-based resin as a binder resin, a plasticizer preferably has a content of 25 to 100 parts by weight with respect to 100 parts by weight of the binder resin. When the content of a plasticizer is too small, a green sheet is liable to be fragile; when too large, the plasticizer is liable to leak out, so that handling is difficult.

Then, by using the dielectric paste, a green sheet 10a is formed with a thickness of preferably 0.5 to 30 μm, more preferably 0.5 to 10 μm, on a third carrier sheet 30 as a third support sheet by doctor blade method, etc., as shown in FIG. 4A. The green sheet 10a is dried after being formed on the third carrier sheet 30. A drying temperature of the green sheet 10a is preferably 50 to 100° C.; and a drying time is preferably 1 to 20 minutes. The thickness of the green sheet 10a is reduced to 5 to 25% of that before drying.

(2) In addition to the above third carrier sheet 30, a first carrier sheet 20 as a first support sheet is prepared to form a release layer 22 thereon, as shown in FIG. 2. A predetermined pattern of an electrode layer 12a is formed on the release layer 22. A blank pattern layer 24 having a thickness substantially same as that of the electrode layer is formed on the surface of the release layer 22 on which the electrode layer is not formed.

As the carrier sheets 20 and 30, for example, a polyester film such as PEN film and PET film is used. The film is preferably coated with a light parting agent such as silicon or alkyd resin to improve peeling property. Thicknesses of these carrier sheets 20 and 30 are, although not particularly limited, preferably 5 to 100 μm. The thicknesses of these carrier sheets 20 and 30 may either be same or not.

The release layer 22 preferably includes dielectric particles same as those constituting green sheet 10a shown in FIG. 3A. Also, the release layer 22 includes a binder, a plasticizer and an optional component, i.e., a parting agent, in addition to dielectric particles. A particle size of the dielectric particle may be same as that of the dielectric particle included in green sheet, but is preferably smaller.

In the present embodiment, the thickness t2 of the release layer 22 is preferably smaller than the thickness t1 of the electrode layer 12a. The thickness t2 is set to preferably 60% or less than, further preferably 30% of or less than, the thickness t1.

As a coating method of the release layer 22, although not particularly limited, for example, the coating method using a wire bar coater is preferable since the release layer 22 is required to be made very thin. Note that it is possible to adjust the thickness of the release layer 22 by selecting a wire bar coater with different wire diameter. Namely, a wire bar coater with smaller wire diameter may be selected to make the coating thickness of the lease layer thinner; while a wire bar coater with larger wire diameter may be selected to form thicker release layer. The release layer 22 is dried after being coated. A drying temperature is preferably 50 to 100° C.; and a drying time is preferably 1 to 10 minutes.

A binder for the release layer 22 is, for example, composed of acrylic resin, polyvinyl butyral, polyvinyl acetal, polyvinyl alcohol, polyolefin, polyurethane, polystyrene, or organic matter or emulsion consisting of copolymer thereof. The binder included in the release layer 22 may be either same as or different from that included in the green sheet 10a, but is preferred to be the same. As the binder, it is particularly preferable to use polyacetal resin.

As a plasticizer for the release layer 22, although not particularly limited, there may be mentioned, for example, phthalate ester, adipic acid, phosphate ester, glycols, etc. The plasticizer included in the release layer 22 may be either same as or different from that included in the green sheet 10a.

As a parting agent for the release layer 22, although not particularly limited, there may be mentioned, for example, paraffin, wax, silicone oil, etc. The parting agent included in the release layer 22 may be either same as or different from that included in the green sheet 10a.

The binder is included in the release layer 22 in an amount of preferably 2.5 to 200 parts by weight or so, more preferably 5 to 30 parts by weight or so and particularly preferably 8 to 30 parts by weight or so, with respect to 100 parts by weight of the dielectric particles.

The plasticizer is included in the release layer 22 in an amount of preferably 0 to 200 parts by weight or so, more preferably 20 to 200 parts by weight or so and particularly preferably 50 to 100 parts by weight or so, with respect to 100 parts by weight of the dielectric particles.

The parting agent is included in the release layer 22 in an amount of preferably 0 to 100 parts by weight or so, more preferably 2 to 50 parts by weight or so and particularly preferably 5 to 20 parts by weight or so, with respect to 100 parts by weight of the dielectric particles.

After forming the release layer on the surface of the third carrier sheet, an electrode layer 12a later-constituting an internal electrode layer 12 after firing, is formed on the surface of the release layer 22 in a predetermined pattern as shown in FIG. 2. The thickness t1 of the electrode layer is preferably 0.1 to 5 μm or so, more preferably 0.1 to 1.5 μm or so. The electrode layer may be composed of a single layer or a plurality of layers with at least 2 types of different compositions.

The electrode layer 12a can be formed on the surface of the release layer 22, for example, by a thick-film forming method such as a printing method using an electrode paste, or by a thin-film method such as evaporation coating or sputtering. When using a screen printing method or a gravure printing method, which is one of the thick-film methods, the electrode layer 12a is formed on the surface of the release layer 22 as below.

First, an electrode paste is prepared. The electrode paste is obtained by kneading conductive materials consisting of a variety of conductive metals and alloys, or a variety of oxides later-becoming the above mentioned conductive materials after firing, organic metallic compounds, or resinate, etc., with an organic vehicle.

As conductive materials used for producing an electrode paste, Ni, Ni alloy or mixture of these are used. Such conductive materials are not particularly limited in shape and may have spherical or scale-like shape, etc., alternatively, a mixture of these different shapes. An average particle size of the conductive materials is normally 0.1 to 2 μm or so, preferably 0.2 to 1 μm or so.

The organic vehicle includes a binder and a solvent. As a binder, for example, there may be mentioned ethyl cellulose, acrylic resin, polyvinyl butyral, polyvinyl acetal, polyvinyl alcohol, polyolefine, polyurethane, polystyrene, or copolymer thereof. Particularly preferable examples are butyrals such as polyvinyl butyral.

The binder is included in the electrode paste in an amount of preferably 4 to 20 parts by weight with respect to 100 parts by weight of conductive materials (metal powders). As a solvent, for example, any known solvent such as terpineol, butyl carbitol, kerosene, etc. can be used. A content of the solvent is preferably about 20 to 55 wt % per entire weight of the paste.

The electrode paste preferably includes a plasticizer for improving an adhesion property. As a plasticizer, there may be mentioned phthalate ester such as benzyl butyl phthalate (BBP), adipic acid, phosphate ester, glycols, etc. An amount of the plasticizer in the electrode paste is preferably 10 to 300 parts by weight, more preferably 10 to 200 parts by weight, with respect to 100 parts by weight of the binder. Alternatively, an acrylic binder having a glass transition temperature Tg below room temperature (lauryl methacrylate, ethylhexyl methacrylate, lauryl acrylate, ethylhexyl acrylate, butyl acrylate, etc.) is added to the electrode paste in an amount of preferably 10 to 100 parts by weight with respect to 100 parts by weight of the binder. Also, a tackiness agent may be added to the electrode paste in an amount of 100 parts by weight or less with respect to 100 parts by weight of the binder. Note that too many amounts of the plasticizer or tackiness agent tend to lower the strength of the electrode layer 12a significantly. Furthermore, it is preferable to improve adhesion properties and/or tackiness of the electrode paste by adding the plasticizer and/or tackiness agent to the electrode paste for improving transferability of the electrode layer 12a.

As a tackiness agent, although not particularly limited, for example, there may be mentioned butyl acrylate (BA), ethylhexyl-2-acrylate (2HEA), lauryl methacrylate (RMA), etc.

After or before forming an electrode paste layer on the surface of the release layer 22 in a predetermined pattern by a printing method, a blank pattern layer 24 having a thickness substantially same as that of the electrode layer 12a is formed on the surface of the release layer 22 on which the electrode layer 12a is not formed. The blank pattern layer 24 is composed of same materials of the green sheet 10a shown in FIG. 3A, and formed in a same way. The electrode layer 12a and blank pattern layer 24 are dried if needed. A drying temperature is, although not particularly limited, preferably 70 to 120° C.; and a drying time is preferably 5 to 15 minutes.

By forming the release layer 22, the electrode layer 12a and the blank pattern layer 24 are adhered to a first carrier sheet 20, with a peeling strength of preferably 10 to 60 mN/cm and more preferably 15 to 40 mN/cm.

(3) In addition to the above carrier sheets 20 and 30, there is prepared an adhesion layer transfer sheet, i.e. a second carrier sheet 26 as a second support sheet on which an adhesion layer 28 is formed, as shown in FIG. 2. The second carrier sheet 26 is composed of a sheet same as those of the carrier sheets 20 and 30. The adhesion layer 28 is adhered to the second carrier sheet 26, with a peel strength of preferably 10 mN/cm or smaller and more preferably 8 mN/cm or smaller.

The composition of the adhesion layer 28 is same as in the release layer 22, except for not including dielectric particles. Namely, the adhesion layer 28 includes a binder, a plasticizer and a parting agent. The adhesion layer 28 may include dielectric particles same as those constituting the green sheet 10a, but it is better not to include dielectric particles when forming an adhesion layer with a thickness smaller than the particle size of the dielectric particles. Also, when including dielectric particles in the adhesion layer 28, a weight ratio of the dielectric particles to the binder is preferably smaller than that of the dielectric particles included in the green sheet to the binder.

The binder and plasticizer for the adhesion layer 28, although preferably same as those for the release layer 22, may be different.

The plasticizer is included in the adhesion layer 28 in an amount of 0 to 200 parts by weight, preferably 20 to 200 parts by weight and furthermore preferably 20 to 100 parts by weight, with respect to 100 parts by weight of the binder.

The thickness of the adhesion layer 28 is preferably 0.02 to 0.3 μm or so. When the thickness of the adhesion layer 28 is too thin, an adhesion force may be reduced while too thick adhesion layer tends to cause generating defects (spaces).

The adhesion layer 28 is formed on the surface of the second carrier sheet 26 as the second support sheet, for example, by a bar coater method, a die coater method, a reverse coater method, a dip coater method, a kiss coater method, etc. followed by optional drying. A drying temperature is, although not particularly limited, preferably room temperature to 80° C.; a drying time is preferably 1 to 5 minutes.

(4) A transfer method is employed in the present embodiment to form an adhesion layer on surfaces of an electrode layer 12a and blank pattern layer 24, shown in FIG. 2. Namely, carrier sheets 20 and 26 are fed between a pair of a first and second transfer rolls 40 and 42 so that a rear surface of the first carrier sheet 20 makes contact with the first transfer roll 40 and a rear surface of the second carrier sheet 26 makes contact with the second transfer roll 42, as shown in FIG. 3 (feeding direction X).

The first carrier sheet 20 is linearly fed between the first and second transfer rolls 40 and 42, and the second carrier sheet 26 is fed between the first and second transfer rolls with a first predetermined angle θ1, and output with a second predetermined angle θ2, with respect to the first carrier sheet 20.

The first predetermined angle θ1 is, although not particularly limited, preferably 10 to 70°, furthermore preferably 30 to 60o. Also, the second predetermined angle θ2 is, although not particularly limited, preferably, 10 to 700, furthermore preferably 30 to 600.

When the first predetermined angle θ1 is too small, air bubbles are liable to be trapped, so that the sheet easily gets wrinkles, etc. Note that an upper limit is actually present for the degree of angle of θ1 because of a configuration of a machine wherein a pressure device is placed above an upper transfer roll. Even if placing the pressure device in a lower roller side, too large θ1 results in restricting θ2 since it is necessary to rewind a removed support body 26. Also, the second predetermined angle θ2 is too small, the adhesion layer 28 is difficult to be transferred due to increased peel force; when too large, peel force is increased due to an influence by static electricity, etc., to cause defects on peeling off.

In this embodiment, a first transfer roll 40 is heated at a first predetermined temperature T1 (° C.), and a second transfer roll 42 is heated at a second predetermined temperature T2 (° C.). The first predetermined temperature T1 and second predetermined temperature T2 satisfy:
60<T1<110, preferably 80<T<100,
90<T2<135, preferably 100<T2<120, and
190<T1+T2, preferably 195<T1+T2≦220.

When the first predetermined temperature T1 is too low, an adhesive strength is liable to be lowered, so that transfer is not performed favorably. On the other hand, too high temperature T1 makes the sheet easy to get wrinkles, so that stacking may be harder in a subsequent step. Also, when a second predetermined temperature T2 is too low, an adhesive strength is liable to be lowered, so that transfer is not performed favorably. On the other hand, too high temperature T2 makes the sheet easy to get wrinkles, so that stacking may be harder in a subsequent step. Furthermore, when T1+T2 is too low, an adhesive strength is liable to be lowered, so that transfer is not performed favorably. On the other hand, too high temperature T2 makes the sheet easy to get wrinkles, so that stacking may be harder in a subsequent step.

Note that a means for heating each roll 40 and 42, althogh not particularly limited, for example, may be heaters, etc., installed into the rolls 40 and 42. Alternatively, heated oil, etc., may be circulated.

In the pair of rolls 40 and 42, a first transfer roller 40 pressed to the first carrier sheet 20 is comprised of a metal roller lined with a rubber layer, and a second transfer roller 42 pressed to the second carrier sheet 26 is comprised of a metal roller with n exposed metal surface. A hardness of the lined rubber layer is 70 to 90 in Durometer hardness according to JIS-K7125; and a thickness of the lining is preferably 1 to 5 mm.

A feeding speed of the first and second carrier sheets 20 and 26 is, although not particularly limited, preferably 1 to 10 m/min. When the feeding speed is too slow, it is liable to reduce productivity; when the speed is too high, a transfer of the adhesion layer may not be favorably done.

An applied pressure to the carrier sheet 20 and 26 due to the pair of rolls 40 and 42 is, although not particularly limited, preferably 0.2 to 6 MPa. When the pressure is too small, a transfer may become harder; and when too large, the pattern of the electrode layer 12a may be broken down, which are both not favorable.

As shown in FIG. 3, the adhesion layer 28 on the second carrier sheet 26 is pressed to surfaces of the electrode layer 12a and the blank pattern layer 24, and heated to apply pressure in the rolls 40 and 42. Then, by removing the second carrier sheet 26, the adhesion layer 28 is transferred to the surfaces of the electrode layer 12a and the blank pattern layer 24.

After that, as shown in FIG. 4A to FIG. 4C, a green sheet 10, formed on the surface of a third carrier sheet 30, is adhered on the surfaces of the electrode layer 12a and blank pattern layer 24. As a method for that, as with the above mentioned method, the transfer method using a pair of rolls 40 and 42 can be used. Namely, the carrier sheets 20 and 30 are let through between rolls so that the first carrier sheet 20 on the top of which the adhesion layer 28 is formed is applied to the rear surface of the first transfer roll 40 and the rear surface of the third carrier sheet 30 on the surface of which the green sheet 10a is formed is applied to the rear surface of the second transfer roll 42. As a result, the green sheet 10a is transferred to the surface of the adhesion layer 28 as shown in FIG. 4C.

As a result of these steps, a multilayer body unit U1, wherein a single green sheet 10a and a single layered electrode layer 12a in a predetermined pattern are stacked, is formed. To repeatedly stack the green sheet 10a on which an electrode layer 12a is formed, for example, steps shown in FIG. 2 to FIG. 4C may be repeated. Alternatively, the multilayer body unit U1 may be stacked via the adhesion layer. Thus, a multilayer body, wherein pulrarities of the electrode layer 12a and green sheet 10a are alternately stacked, can be obtained. Note that the adhesion layer 28 may be formed on the surface of the green sheet 10a shown in FIG. 4C. When forming the adhesion layer 28 by the transfer method, same procedures can be employed as those used when transferring the adhesion layer 28 on the surface of electrode layer 12a, as shown in FIG. 3.

(5) Then, after applying final pressure on the multilayer body, the first carrier sheet 20 is removed. The final pressure applied is preferably 10 to 200 MPa. Also, a heating temperature is preferably 40 to 100° C. The multilayer body is then cut into a predetermined size to form a green chip. The green chip is subject to binder removal process and firing process, followed by heating process to reoxidize the dielectric layer.

The binder removal process may be performed in normal conditions, but it is preferable to perform particularly in the following conditions when using base metal such as Ni and Ni alloy for conductive materials in the internal electrode layer.

temperature rising rate: 5 to 300° C./hour,

holding temperature: 200 to 400° C.,

holding time: 0.5 to 20 hours, atmosphere: wet mixed gas of N₂ and H₂.

Preferred firing conditions are as follows.

temperature rising rate: 50 to 500° C./hour, holding temperature: 1100 to 1300° C.,

holding time: 0.5 to 8 hours,

temperature cooling rate: 50 to 500° C./hour,

atmosphere gas: wet mixed gas of N₂ and H₂, etc.

Note that oxygen partial pressure of air atmosphere at firing is preferably 10⁻² Pa or less, particularly preferably 10⁻² to 10⁻⁸ Pa. When exceeding the above range, the internal electrode layer may be oxidized; and too low oxygen partial pressure may cause abnormal sintering of electrode materials in the internal electrode layer resulting in electrode breaking.

In the heating process followed by the above firing process, a holding temperature or maximum temperature is preferably 1000° C. or higher, furthermore preferably 1000 to 1100° C. When the holding temperature or maximum temperature in the heating process is below the above range, oxidization of dielectric materials may be insufficient to cause shortening dielectric resistance lifetime; and when exceeding the above range, Ni in the internal electrode may be oxidized to cause not only lowering capacity, but also reacting with a dielectric substrate to shorten the lifetime as well. Oxygen partial pressure in the heating process is higher than that in the firing reduced atmosphere, and is preferably 10⁻³ Pa to 1 Pa, more preferably 10⁻² Pa to 1 Pa. Below the above range, it is difficult to reoxidize the dielectric layer 10; and when exceeding the above range, the internal electrode layer 12 is liable to be oxidized. Other heating conditions are preferably as below.

holding time: 0 to 6 hours,

temperature cooling rate: 50 to 500° C./hour,

atmosphere gas: wet N₂ gas, etc.

Note that a wetter, etc. can be used to wet N₂ gas and mixed gas, etc., for example. In this case, water temperature is preferably 0 to 75° C. or so. Also, binder removal process, firing process and heating process may be performed continuously or independently. When performing the processes continuously, it is preferred to change an atmosphere without cooling after the binder removal process; to rise temperature to the holding temperature at firing to perform firing process followed by cooling; and to change an atmosphere to perform heating process when temperature is cooled to the holding temperature of heating process. On the other hand, when performing the processes independently, it is preferred at firing to rise temperature to the holding temperature of binder removal process under an atmosphere of N₂ gas or wet N₂ gas; to change the atmosphere to continue to rise temperature; and continue to rise temperature; and to change the atmosphere again to N₂ gas or wet N₂ gas after cooling temperature to the holding temperature of heating process, for continuing to cool. Also at heating, the atmosphere may be changed after rising temperature to the holding temperature under N₂ gas atmosphere, or may be kept unchanged to perform whole heating process under wet N₂ gas atmosphere.

Thus-obtained sintering body (element body 4) is subject to end surface polishing by barrel-polishing, sand blasting, etc., for example, and a terminal electrode paste is then baked thereon to form terminal electrodes 6 and 8. Preferably, the terminal electrode paste is fired, for example, in wet mixed gas of N₂ and H₂, at 600 to 800° C., for 10 minutes to 1 hour or so. A pad layer is formed, if needed, by plating on the terminal electrodes 6 and 8. Note that the terminal electrode paste may be prepared as with the above-mentioned electrode paste.

Thus-produced multilayer ceramic capacitor of the present invention can be mounted on a printed-circuit board by soldering, etc., and used in a variety of electronic systems.

In the method of production of the multilayer ceramic capacitor according to the present embodiment, as shown in FIG. 3, when transferring the adhesion layer 28 to surfaces of the electrode layer 12a and the blank pattern layer 24, the carrier sheets 20 and 26 are fed between the first and second transfer rolls 40 and 42, and the rolls 40 and 42 are heated to a predetermined temperature. At this time, by controlling the roll temperature to satisfy temperature conditions of the present invention, the adhesion layer 28 having sufficient adhesive strength can be obtained without any wrinkles on the sheet 20, so that the adhesion layer 28 can be favorably transferred. As a result, green sheet 10a and electrode layer 12a can be favorably stacked to produce an electronic device having an internal electrode suitable for stacking more layers and making layers thinner.

Also, in the present embodiment, a dry type electrode layer 12a can be transferred, easily and with high accuracy, to the surface of the green sheet 10a, without breaking or deforming the green sheet 10a.

Particularly in the method of production of the present embodiment, the adhesion layer 28 is formed on the surface of the electrode layer by transfer method, and the green sheet 10a is adhered to the surface of the electrode layer 12a via the adhesion layer 28. By forming the adhesion layer 28, high pressure and heat are not required when transferring the green sheet 10a to the surface of the electrode layer 12a, so that it is possible to adhere the green sheet at low pressure and temperature. Therefore, even when the green sheet 10a is very thin, the electrode layer 12a and the green sheet 10a can be well stacked without breaking the green sheet 10a, and no short circuit failure, etc., is caused.

Also, for example, by making an adhesion force of the adhesion layer 28 stronger than a tack strength of the release layer 22, and making a peel force of the release layer 22 stronger than tack strength between the green sheet 10a and the third carrier sheet 30, etc., it is possible to remove, selectively and easily, the third carrier sheet 30 of the green sheet 10a side.

Furthermore, since the adhesion layer 28 is formed on the surface of the electrode layer 12a or green sheet 10a by transfer method, not formed directly by a coating method, etc., in the present embodiment, a component of the adhesion layer 28 does not leak in the electrode layer 12a or green sheet 10a, and it is possible to form very thin adhesion layer 28. The thickness of the adhesion layer 28 can be made thin, for example, to 0.02 to 0.3 μm or so. Even when the thickness of the adhesion layer 28 is smaller, no leaking of a component of the adhesion layer 28 in the electrode layer 12a or green sheet 10a results in sufficient adhesion force and no bad effects on compositions of the electrode layer 12a or green sheet 10a

### Second Embodiment

Although the carrier sheets 20 and 26 are not preliminarily heated at front side of feeding direction X of the transfer rolls 40 and 42 shown in FIG. 3 in the method of the above mentioned first embodiment, a method of the second embodiment employs preliminary heating devices 50 and 52 to preliminarily heat carrier sheets 20 and 26. Preliminary heating devices 50 and 52, although not particularly limited, for example, there may be mentioned infrared heater, metallic beads heater, infrared lamp, hot-air heater, etc.

In the second embodiment, the carrier sheets 20 and 26 are preliminarily heated, and heating temperatures T1 and T2 of the rolls 40 and 42 respectively are set to satisfy:
60<T1<110, preferably 80<T1<100,
80≦T2<135, preferably 80<T2<100 and
170<T1+T2, preferably 180≦T1+T2≦200,
   which allows a favorable transfer of the adhesion layer 28.

Note that heating temperature by each of preliminary heating devices 50 and 52 is 80° C. or higher, preferably 80 to 100° C.

According to the method of the present embodiment, in addition to the effects in the method of the above mentioned first embodiment, the following effects are also attained. Namely, it is possible in the method of the second embodiment to lower the heating temperature of the transfer rolls 40 and 42 and to increase feeding speed (transfer speed) of the carrier sheets 20 and 26 fed between a pair of the transfer rolls 40 and 42, compared to the method of the first embodiment. Namely, even if the feeding speed (transfer speed) of the carrier sheets 20 and 26 fed between the pair of the transfer rolls 40 and 42 is increased to, for example, 4 times or so, it is possible to well transfer the adhesion layer 28 having sufficient adhesive strength without wrinkles of the sheet 20.

Note that a favorable transfer is possible even when increasing transfer speed in the method of the present embodiment while a favorable transfer is difficult when increasing transfer speed in the case without preliminary heating (the method of the first embodiment). Since the other compositions and effects of the present invention are same as with the first embodiment, the detailed description is omitted.

### Third Embodiment

In the third embodiment of the present invention, as shown in FIG. 3, either one of first and second transfer rolls is heated while the other is not heated when transferring an adhesion layer 28 to surfaces of electrode layer 12a and blank pattern layer 24. A carrier sheet 20 or 26 to be making contact with the other not-heated transfer roll 40 or 42 is preliminarily heated at a temperature of 80° C. or higher, preferably 135° C. or lower and furthermore preferably 100° C. or lower, before making contact with the transfer roll.

When heating the roll 40 for example, the roll 40 is preliminarily heated at least by a heating device 52 without heating the roll 42. In this case, a preliminary heating device 50 may be used as well for preliminary heating.

Alternatively, when heating the roll 42, the roll 42 is preliminarily heated at least by the heating device 50 without heating the roll 40. In this case, the preliminary heating device 52 may be used as well for preliminary heating.

The method according to the third embodiment also allows well transferring the adhesion layer 28 to surfaces of the electrode layer 12a and blank pattern layer 24. Note that a range of conditions for a favorable transfer is small in the third embodiment compared to the methods of the first embodiment and second embodiment. Since the other compositions and effects of the present invention are same as with the first embodiment or second embodiment, the detailed description is omitted.

### Other Embodiment

Note that the present invention is not limited to the above mentioned embodiments, and can be variously modified within the scope of the present invention.

For example, the methods of the present invention can be applied to production of any other electronic devices having an internal electrode in addition to production of a multilayer ceramic capacitor.

Hereinafter, the present invention will be explained in detail based on examples and comparative examples, but the present invention is not limited to the examples.

### Comparative Example 1

First, each of the following pastes was prepared.

### Green Sheet Paste

BaTiO₃ powder (BT-02/Sakai Chemical Industry Co., Ltd.) was wet mixed with powder selected from MgCO₃, MnCO₃, (Ba_{0.6}Ca_{0.4})SiO₃ and rare earth compounds (Gd₂O₃, Tb₄O₇, Dy₂O₃, Ho₂O₃, Er₂O₃, Tm₂O₃, Yb₂O₃, Lu₂O₃ and Y₂O₃) in a ball mill for 16 hours, and then dried to obtain dielectric materials. The average particle size of the raw powder was 0.1 to 1 μm.

(Ba_{0.6}Ca_{0.4})SiO₃ was obtained by wet mixing of BaCO₃, CaCO₃ and SiO₂ in a ball mill for 16 hours, followed by drying, and then firing at 1150° C. in an air to wet pulverize in a ball mill for 100 hours.

To make a paste of dielectric materials, organic vehicle was added to the dielectric materials, and mixed in a ball mille, so that a dielectric green sheet paste was obtained. Organic vehicle was composed of 6 parts by weight of polyvinyl butyral as a binder, 3 parts by weight of bis(2-ethylhexyl)phthalate (DOP) as a plasticizer, 55 parts by weight of ethyl acetate, 10 parts by weight of toluene, 0.5 parts by weight of paraffin as a parting agent, with respect to 100 parts by weight of the dielectric materials.

### Release Layer Paste

The above dielectric green sheet paste was diluted with ethanol/propanol/xylene (42.5/42.5/15) by 3-fold in weight ratio to obtain a release layer paste.

### Adhesion Layer Paste

In MEK as a solvent, PVB (BM-SH, Sekisui Chemical Co., Ltd., degree of polymerization: 800) in an amount of 2 wt % and DOP in an amount of 1 wt % were dissolved to obtain an adhesion layer paste.

### Internal Electrode Paste (Later-Transferred Electrode Layer Paste)

Next, materials in the following ratios were kneaded by 3 rolls to make a slurry, so that an internal electrode paste was obtained. Namely, to 100 parts by weight of Ni particles having an average particle size of 0.2 μm, 40 parts by weight of an organic vehicle (8 parts by weight of polyvinyl butyral resin as a binder dissolved in 92 parts by weight of terpineol), 10 parts by weight of terpineol and 1 parts by weight of fatty acid ester based dispersant were added and kneaded by 3 rolls to make a slurry, so that the internal electrode paste was obtained.

### Preparation of Blank Pattern Layer Printing Paste

Same ceramic powders and subcomponent additives were prepared in same ratios as those used in the green sheet paste.

Ceramic powders and subcomponent additives (150 g) were added with an ester-based polymer as a dispersant of (1.5 g), terpineol (5 g), acetone (60 g) and dioctyl phthalate as a plasticizer (5 g), and then mixed for 4 hours. Next, the mixture was added with BH6 (polyvinyl butyral resin with degree of polymerization: 1450 and degree of butyral: 69 mol %±3%) made by Sekisui Chemical Co., Ltd. and 8% of lacquer (8 wt % of polyvinyl butyral and 92 wt % of terpineol with respect to the total amount of lacquer), in an amount of 120 g in total, and mixed for 16 hours. Then, surplus solvent of acetone was removed, and terpineol was added in an amount of 40 to 100 g for viscosity control to obtain a paste.

Forming of Green Sheet and Transferring of Adhesion layer and Electrode Layer

First, using the above dielectric green sheet paste, a green sheet with a thickness of 1.0 μm was formed on a PET film with a thickness of 35 μm (third carrier sheet 30) by a wire bar coater. Next, a release layer with a thickness of 0.1 μm was formed on another PET film with same thickness (first carrier sheet 20) by coating the above release layer paste by a wire bar coater followed by drying.

An electrode layer 12a and blank pattern layer 24 were formed on the surface of the release layer. The electrode layer 12a was formed to have a thickness of 1 μm by printing method using the above internal electrode paste. The blank pattern layer 24 was formed to have a thickness of 1 μm by printing method using the above blank pattern layer paste. The electrode layer 12a and blank pattern layer 24 had a peel strength to the PET films of 35.2 mN/cm.

Also, an adhesion layer 28 was formed on another PET film with same thickness (second carrier sheet 26). The adhesion layer 28 was formed to have a thickness of 0.1 μm using the above adhesion layer paste by a wire bar coater. A peeling strength of the adhesion layer 28 was 2.5 mN/cm to the PET film.

Next, the adhesion layer 28 on the second carrier sheet 26 was intended to transfer to surfaces of the internal electrode layer 12a and the blank pattern layer 24 on the first carrier sheet 20 in a method shown in FIG. 3. When transferring, a pair of rolls 40 and 42 shown in FIG. 3 were used; only a second transfer roller 42 placed on the upper side in FIG. 1 was heated at a temperature shown in Table 1 (100 to 150° C.) while a first transfer roller 40 placed on the lower side was not heated. Preliminary heating was not performed by preliminary heating device 50 and 52 as well.

Transfer pressure, applied to carrier sheets 20 and 26 by the rollers 40 and 42, was 1.2 MPa. Carrying speed (same as feeding speed and output speed) of carrier sheets 20 and 26 was 1 m/min.

Next, the green sheet 10a was intended to transfer on surfaces of internal electrode layer 12a and blank pattern layer 24, via the adhesion layer 28, as shown in FIG. 4A to FIG. 4C, by using a system shown in FIG. 3, in the conditions as above, to form a multilayer body unit U1.

As shown in Table 1 (as well as other tables), temperatures of the surface of the first carrier sheet 20 after passing through the rolls 40 and 42 were measured, which correspond to work temperature T3 in Table 1. Note that work temperature T3 was measured by putting thermolabels on the midportion and both marginal portions of the surface of green sheet when transferring the green sheet after passing through the rolls. Also, work temperature T3 was measured by putting thermolabels on the midportion and both marginal portions of the surface of the electrode layer when no green sheet was transferred after passing through the rolls.

Next, by using a surface roughness meter, filtered center-line waviness (Wca) of a rear surface of the first carrier sheet 20 on which thus obtained multilayer body unit U1 was formed was measured according to JIS B0610. Results are shown in Table 1. In Table 1, the filtered center-line waviness (Wca) is expressed as wrinkles in micrometers.

The wrinkles is preferably 10 μm or less for the following two reasons. The first reason is that (1) a heaving carrier sheet causes loss of precision when determining a stacking position by image processing to deteriorate accuracy in stacking. The second reason is that (2) air bubbles are generated in a multilayer body due to trapping air at stacking. Therefore, heaving of the carrier sheet has to be 10 μm or less.

Furthermore, a test specimen with a dimension of 10 mm×10 mm was cut from the multilayer body unit U1. Double-faced tape was applied both on the surface of green sheet 10a and the rear surface of electrode layer 12a (including blank pattern layer 24) Adhesive strength of the adhesion layer 28 in the multilayer body unit U1 was measured by pulling out the two piece of the tape at a rate of 8 mm/min. Results are shown in Table 1.

Electrode layer 12a has to be separated from the first carrier sheet 20 in the last result, and adhesive strength of the adhesion layer 28 is required to be larger than peel strength of the release layer 22. Therefore, adhesive strength of the adhesion layer 28 is preferably 35N/cm² or more. “FINE” and “FAILED” in the column of “Transfer” of Table 1 indicate adhesive strength of 35N/cm² or more and less than 35N/cm², respectively.

In the column of “Total Judgment” of Table 1, requirements for “FINE” are determined: wrinkles of 10 μm or less and adhesion force of 35N/cm² or more due to transfer between the electrode and green sheet. As shown in Table 1, change in temperature did not cause to improve transferring results in Comparative Example 1 (sample no. 1 to 5), wherein only the second transfer roll 42 on the upper side in FIG. 3 was heated.

### Comparative Example 2

Except for heating only a first transfer roll 40 on the lower side in FIG. 3, as shown in Table 1, at 100 to 150° C., a multilayer body unit U1 shown in FIG. 4C was formed as with Comparative Example 1 to measure work temperature T3, wrinkles and adhesive strength and to perform evaluation on transfer and total judgment. The results are shown in Table 1. As shown in Table 1, good transferring results cannot be obtained regardless of temperature differences in Comparative Example 2 (sample no. 6 to 10), wherein only the first transfer roll 40 on the lower side in FIG. 3 was heated.

### Example 1

Except for heating a first transfer roll 40 on the lower side and a second transfer roll 42 on the upper side respectively in FIG. 3, at a temperature shown in Table 2, a multilayer body unit U1 shown in FIG. 4C was formed as with Comparative Example 1 to measure work temperature T3, wrinkles and adhesive strength and to perform evaluation on transfer and total judgment. The results are shown in Table 2. Note that there was no preliminary heating by preliminary heating devices 50 and 52 shown in FIG. 3 in Example 1.

In Example 1 (sample no. 11 to 36), wherein the first transfer roll 40 and second transfer roll 42 were both heated, it was confirmed that transferring was well performed to obtain favorable total judgment, as shown in Table 2, when a first predetermined temperature T1 and a second predetermined temperature T2 satisfy:
60<T1<110, preferably 80≦T1≦100,
90≦T2<135, preferably 100≦T2≦120 and
190<T1+T2, preferably 195≦T1+T2≦220.
   Preferred work temperature was also confirmed to be 80° C. or higher.

Furthermore, it was confirmed that transferring was well performed depending on conditions, which were narrow in the range, even in the case of T1>T2, in the present Example 1; but that conditions for good transfer is larger in the case of T1<T2.

### Comparative Example 3

Except for heating a second transfer roll 42 on the upper side as well as a second preliminary heating device 52 on the upper side respectively in FIG. 3 without heating the other roll 40 and preliminary heating device 50, a multilayer body unit U1 shown in FIG. 4C was formed as with Comparative Example 1 to measure work temperature T3, wrinkles and adhesive strength and to perform evaluation on transfer and total judgment. The results are shown in Table 3.

As shown in Table 3, change in temperature did not cause to improve transferring results in Comparative Example 3 (sample no. 37 to 41), wherein the second transfer roll 42 on the upper side and second preliminary heating device 52 on the upper side respectively in FIG. 3 were heated.

### Example 2

Except for heating a second transfer roll 42 on the upper side as well as a first preliminary heating device 50 on the lower side respectively in FIG. 3 without heating the other roll 40 and preliminary heating device 52, a multilayer body unit U1 shown in FIG. 4C was formed as with Comparative Example 1 to measure work temperature T3, wrinkles and adhesive strength and to perform evaluation on transfer and total judgment. The results are shown in Table 3.

As shown in Table 3, it was confirmed that transferring was well performed depending on temperature conditions in Example 2 (sample no. 42 to 50), wherein the second transfer roll 42 on the upper side and the preliminary heating device 50 on the lower side respectively in FIG. 3 were heated. In this example, it was also confirmed that a preliminary heating temperature by the preliminary heating device 50 is preferably 90 to 100° C.; and that a heating temperature of roll 42 is preferred around 120° C.

### Example 3

Except for heating a second transfer roll 42 on the upper side as well as preliminary heating devices 50 and 52 on the lower and upper sides respectively in FIG. 3 without heating the other roll 40, a multilayer body unit U1 shown in FIG. 4C was formed as with Comparative Example 1 to measure work temperature T3, wrinkles and adhesive strength and to perform evaluation on transfer and total judgment. The results are shown in Table 3.

As shown in Table 3, it was confirmed that transferring was well performed depending on temperature conditions in Example 3 (sample no. 51 to 59), wherein the second transfer roll 42 on the upper side in FIG. 3 and preliminary heating devices 50 and 52. In this example, it was also confirmed that a preliminary heating temperature by preliminary heating devices 50 and 52 is preferably 90 to 100° C.; and that a heating temperature of the roll 42 is preferably around 110 to 120° C.

### Example 4

Except for heating a first transfer roll 40 on the lower side as well as a second preliminary heating device 52 on the upper side respectively in FIG. 3 without heating the other roll 42 and preliminary heating device 50, a multilayer body unit U1 shown in FIG. 4C was formed as with Comparative Example 1 to measure work temperature T3, wrinkles and adhesive strength and to perform evaluation on transfer and total judgment. The results are shown in Table 3.

As shown in Table 4, it was confirmed that transferring was well performed depending on temperature conditions in Example 4 (sample no. 60 to 66), wherein the first transfer roll 40 on the lower side in FIG. 3 and preliminary heating device 52 were heated. In this Example, it was also confirmed that a preliminary heating temperature by the preliminary heating device 52 is preferably 90 to 110° C.; and that a heating temperature of the roll 40 is preferably around 100° C.

### Comparative Example 4

Except for heating a first transfer roll 40 on the lower side as well as a first preliminary heating device 50 on the lower side respectively in FIG. 3 without heating the other roll 41 and preliminary heating device 52, a multilayer body unit U1 shown in FIG. 4C was formed as with Comparative Example 1 to measure work temperature T3, wrinkles and adhesive strength and to perform evaluation on transfer and total judgment. The results are shown in Table 4.

As shown in Table 4, change in temperature did not cause to improve transferring results in Comparative Example 4 (sample no. 67 to 71), wherein the first transfer roll 40 on the lower side in FIG. 3 and the preliminary heating device 50 on the lower side were heated.

### Example 5

Except for heating a first transfer roll 40 on the lower side as well as preliminary heating devices 50 and 52 on the lower and upper sides respectively in FIG. 3 without heating the other roll 42, a multilayer body unit U1 shown in FIG. 4C was formed as with Comparative Example 1 to measure work temperature T3, wrinkles and adhesive strength and to perform evaluation on transfer and total judgment. The results are shown in Table 4.

As shown in Table 4, it was confirmed that transferring was well performed depending on temperature conditions in Example 5 (sample no. 72 to 77), wherein the first transfer roll 40 on the lower side in FIG. 3 and preliminary heating devices 50 and 52. In this example, it was also confirmed that a preliminary heating temperature by preliminary heating devices 50 and 52 is preferably around 90° C.; and that a heating temperature of the roll 40 is preferably around 100° C.

### Example 6

Except for heating the first transfer roll 40 on the lower side and a second transfer roll 42 on the upper side as well as first and second preliminary heating devices 50 and 52 on the lower and upper sides respectively in FIG. 3, a multilayer body unit U1 shown in FIG. 4C was formed as with Comparative Example 1 to measure work temperature T3, wrinkles and adhesive strength and to perform evaluation on transfer and total judgment. The results are shown in Table 5.

As shown in Table 5, in Example 6 (sample no. 78 to 97), wherein all rolls 40 and 42 and preliminary heating device 50 and 52 in FIG. 3, it was confirmed that transferring was well performed to obtain favorable total judgment, when a first predetermined temperature T1 and a second predetermined temperature T2 satisfy:
60<T1<110, preferably 80≦T1≦100,
80≦T2<135, preferably 80≦T2≦100 and
170<T1+T2, preferably 180≦T1+T2≦200.
   Also, preferable work temperature was confirmed to be 80° C. or more.

### Example 7

Except for changing a carrying speed to 1 to 4 m/min, a multilayer body unit U1 shown in FIG. 4C was formed as with Example 6 to measure work temperature T3, wrinkles and adhesive strength and to perform evaluation on transfer and total judgment. The results are shown in Table 6.

As shown in Table 6, when all rolls 40 and 42 and preliminary heating device 50 and 52 in FIG. 3 are heated, it was confirmed that transferring was well performed with increased carrying speed.

[Table 1]

TABLE 1

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Effects by | 1 | 1 | 100 | — | 100 | — | — | 45 | 2.85 | — | FAILED | FAILED |
| upper roller | 2 | 1 | 110 | — | 110 | — | — | 52.5 | 5.91 | 10.8 | FAILED | FAILED |
| Comparative | 3 | 1 | 120 | — | 120 | — | — | 60 | 7.4 | 13.8 | FAILED | FAILED |
| Example 1 | 4 | 1 | 135 | — | 135 | — | — | 72.5 | 28.39 | 20.3 | FAILED | FAILED |
| | 5 | 1 | 150 | — | 150 | — | — | 80 | 63.63 | 35.1 | FINE | FAILED |
| Effects by | 6 | 1 | — | 100 | 100 | — | — | 50 | 7.6 | — | FAILED | FAILED |
| lower roller | 7 | 1 | — | 110 | 110 | — | — | 52.5 | 20.61 | 11.8 | FAILED | FAILED |
| Comparative | 8 | 1 | — | 120 | 120 | — | — | 62.5 | 51.25 | 14.5 | FAILED | FAILED |
| Example 2 | 9 | 1 | — | 135 | 135 | — | — | 72.5 | 82.4 | 24.6 | FAILED | FAILED |
| | 10 | 1 | — | 150 | 150 | — | — | 82.5 | 442.1 | 35.7 | FINE | FAILED |

PHD = Preliminary Heating Device

TABLE 2

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Heating both | 11 | 1 | 120 | 110 | 230 | — | — | 90 | 22.2 | 39.1 | FINE | FAILED |
| rollers | 12 | 1 | 120 | 100 | 220 | — | — | 87.5 | 9.9 | 38.1 | FINE | FINE |
| Example 1 | 13 | 1 | 120 | 90 | 210 | — | — | 85 | 3.5 | 36.7 | FINE | FINE |
| | 14 | 1 | 120 | 85 | 205 | — | — | 82.5 | 3.9 | 36.0 | FINE | FINE |
| | 15 | 1 | 120 | 80 | 200 | — | — | 80 | 1.9 | 35.2 | FINE | FINE |
| | 16 | 1 | 120 | 60 | 180 | — | — | 75 | 0.77 | 34.2 | FAILED | FAILED |
| | 17 | 1 | 110 | 110 | 220 | — | — | 87.5 | 22.2 | 38.7 | FINE | FAILED |
| | 18 | 1 | 110 | 100 | 210 | — | — | 85 | 9.4 | 38.1 | FINE | FINE |
| | 19 | 1 | 110 | 90 | 200 | — | — | 82.5 | 3.2 | 37.3 | FINE | FINE |
| | 20 | 1 | 110 | 85 | 195 | — | — | 80 | 2.0 | 36.3 | FINE | FINE |
| | 21 | 1 | 110 | 80 | 190 | — | — | 75 | 1.3 | 33.1 | FAILED | FAILED |
| | 22 | 1 | 100 | 110 | 210 | — | — | 85 | 20.8 | 38.1 | FINE | FINE |
| | 23 | 1 | 100 | 100 | 200 | — | — | 80 | 8.2 | 36.3 | FINE | FINE |
| | 24 | 1 | 100 | 90 | 190 | — | — | 80 | 3.4 | 36.3 | FINE | FINE |
| | 25 | 1 | 100 | 85 | 185 | — | — | 72.5 | 1.9 | 32.0 | FAILED | FAILED |
| | 26 | 1 | 90 | 110 | 200 | — | — | 82.5 | 20.6 | 38.1 | FAILED | FAILED |
| | 27 | 1 | 90 | 100 | 190 | — | — | 80 | 7.7 | 36.3 | FINE | FINE |
| | 28 | 1 | 90 | 90 | 180 | — | — | 72.5 | 2.9 | 32.0 | FAILED | FAILED |
| | 29 | 1 | 90 | 85 | 175 | — | — | 70 | 1.7 | 29.7 | FAILED | FAILED |
| | 30 | 1 | 85 | 110 | 195 | — | — | 80 | 20.6 | 36.3 | FINE | FAILED |
| | 31 | 1 | 85 | 100 | 185 | — | — | 75 | 7.6 | 33.7 | FAILED | FAILED |
| | 32 | 1 | 85 | 90 | 175 | — | — | 67.5 | 2.5 | 28.2 | FAILED | FAILED |
| | 33 | 1 | 85 | 85 | 170 | — | — | 65 | 1.4 | 26.7 | FAILED | FAILED |
| | 34 | 2 | 120 | 100 | 220 | — | — | 75 | 8.4 | 33.7 | FAILED | FAILED |
| | 35 | 3 | 120 | 100 | 220 | — | — | 67.5 | 7.3 | 28.2 | FAILED | FAILED |
| | 36 | 4 | 120 | 100 | 220 | — | — | 62.5 | 5.1 | 23.5 | FAILED | FAILED |

PHD = Preliminary Heating Device

[Table 3]

TABLE 3

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Heating upper | 37 | 1 | 120 | — | 120 | 70 | — | 67.5 | 7.51 | 26.5 | FAILED | FAILED |
| roller + upper | 38 | 1 | 120 | — | 120 | 80 | — | 67.5 | 7.94 | 27.8 | FAILED | FAILED |
| PHD | 39 | 1 | 120 | — | 120 | 90 | — | 67.5 | 8.01 | 28.2 | FAILED | FAILED |
| Comparative | 40 | 1 | 120 | — | 120 | 100 | — | 70 | 8.25 | 29.9 | FAILED | FAILED |
| Example 3 | 41 | 1 | 120 | — | 120 | 110 | — | 70 | 8.69 | 31.2 | FAILED | FAILED |
| Heating upper | 42 | 1 | 120 | — | 120 | — | 70 | 72.5 | 8.22 | 32.0 | FAILED | FAILED |
| roller + lower | 43 | 1 | 120 | — | 120 | — | 80 | 77.5 | 8.76 | 34.4 | FAILED | FAILED |
| PHD | 44 | 1 | 120 | — | 120 | — | 90 | 80 | 9.29 | 35.1 | FINE | FINE |
| Example 2 | 45 | 1 | 120 | — | 120 | — | 100 | 80 | 9.62 | 35.4 | FINE | FINE |
| | 46 | 1 | 120 | — | 120 | — | 110 | 80 | 10.72 | 35.9 | FINE | FAILED |
| | 47 | 1 | 110 | — | 110 | — | 90 | 75 | 8.71 | 33.7 | FAILED | FAILED |
| | 48 | 1 | 100 | — | 100 | — | 90 | 72.5 | 8.1 | 32.0 | FAILED | FAILED |
| | 49 | 1 | 90 | — | 90 | — | 90 | 67.5 | 7.31 | 28.2 | FAILED | FAILED |
| | 50 | 2 | 120 | — | 120 | — | 90 | 70 | 7.79 | 30.2 | FAILED | FAILED |
| Heating upper | 51 | 1 | 120 | — | 120 | 70 | 70 | 75 | 8.23 | 33.7 | FAILED | FAILED |
| roller + both | 52 | 1 | 120 | — | 120 | 80 | 80 | 77.5 | 8.77 | 34.4 | FAILED | FAILED |
| PHD | 53 | 1 | 120 | — | 120 | 90 | 90 | 80 | 9.33 | 35.3 | FINE | FINE |
| Example 3 | 54 | 1 | 120 | — | 120 | 100 | 100 | 82.5 | 9.98 | 35.9 | FINE | FINE |
| | 55 | 1 | 120 | — | 120 | 110 | 110 | 87.5 | 11.02 | 38.7 | FINE | FAILED |
| | 56 | 1 | 110 | — | 110 | 100 | 100 | 80 | 8.71 | 35.5 | FINE | FINE |
| | 57 | 1 | 100 | — | 100 | 100 | 100 | 75 | 8.29 | 33.7 | FAILED | FAILED |
| | 58 | 1 | 90 | — | 90 | 100 | 100 | 70 | 7.45 | 30.2 | FAILED | FAILED |
| | 59 | 2 | 120 | — | 120 | 100 | 100 | 72.5 | 7.92 | 32.0 | FAILED | FAILED |

PHD = Preliminary Heating Device

[Table 4]

TABLE 4

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Heating lower | 60 | 1 | — | 100 | 100 | 70 | — | 67.5 | 8.59 | 31.2 | FAILED | FAILED |
| roller + upper | 61 | 1 | — | 100 | 100 | 80 | — | 75 | 8.33 | 32.2 | FAILED | FAILED |
| PHD | 62 | 1 | — | 100 | 100 | 90 | — | 80 | 9.44 | 35.2 | FINE | FINE |
| Example 4 | 63 | 1 | — | 100 | 100 | 100 | — | 80 | 9.89 | 35.5 | FINE | FINE |
| | 64 | 1 | — | 100 | 100 | 110 | — | 82.5 | 9.88 | 35.8 | FINE | FINE |
| | 65 | 1 | — | 100 | 100 | 100 | — | 77.5 | 8.21 | 34.3 | FAILED | FAILED |
| | 66 | 2 | — | 100 | 100 | 110 | — | 75 | 7.89 | 30.2 | FAILED | FAILED |
| Heating lower | 67 | 1 | — | 100 | 100 | — | 70 | 72.5 | 9.38 | 30.8 | FAILED | FAILED |
| roller + lower | 68 | 1 | — | 100 | 100 | — | 80 | 72.5 | 9.87 | 31.6 | FAILED | FAILED |
| PHD | 69 | 1 | — | 100 | 100 | — | 90 | 75 | 10.2 | 31.9 | FAILED | FAILED |
| Comparative | 70 | 1 | — | 100 | 100 | — | 100 | 77.5 | 11.1 | 32.0 | FAILED | FAILED |
| Example 4 | 71 | 1 | — | 100 | 100 | — | 110 | 80 | 14.3 | 35.3 | FINE | FAILED |
| Heating lower | 72 | 1 | — | 100 | 100 | 70 | 70 | 75 | 9.09 | 31.9 | FAILED | FAILED |
| roller + both | 73 | 1 | — | 100 | 100 | 80 | 80 | 77.5 | 9.25 | 34.4 | FAILED | FAILED |
| PHD | 74 | 1 | — | 100 | 100 | 90 | 90 | 80 | 9.94 | 35.2 | FINE | FINE |
| Example 5 | 75 | 1 | — | 100 | 100 | 100 | 100 | 80 | 11.8 | 35.8 | FINE | FAILED |
| | 76 | 1 | — | 100 | 100 | 110 | 110 | 82.5 | 15.5 | 36.3 | FINE | FAILED |
| | 77 | 1 | — | 90 | 90 | 110 | 90 | 75 | 5.68 | 34.2 | FAILED | FAILED |

PHD = Preliminary Heating Device

[Table 5]

TABLE 5

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Heating both | 78 | 1 | 100 | 80 | 180 | 60 | 60 | 70 | 0.7 | 30.2 | FAILED | FAILED |
| rollers + both | 79 | 1 | 100 | 80 | 180 | 70 | 70 | 72.5 | 0.73 | 32.0 | FAILED | FAILED |
| PHD | 80 | 1 | 100 | 80 | 180 | 80 | 80 | 80 | 0.73 | 35.1 | FINE | FINE |
| Example 6 | 81 | 1 | 100 | 80 | 180 | 90 | 90 | 80 | 0.77 | 35.8 | FINE | FINE |
| | 82 | 1 | 100 | 80 | 180 | 100 | 100 | 82.5 | 0.92 | 37.3 | FINE | FINE |
| | 83 | 1 | 100 | 85 | 185 | 60 | 60 | 75 | 0.93 | 33.7 | FAILED | FAILED |
| | 84 | 1 | 100 | 85 | 185 | 70 | 70 | 77.5 | 1.01 | 34.4 | FAILED | FAILED |
| | 85 | 1 | 100 | 85 | 185 | 80 | 80 | 80 | 1.29 | 36.3 | FINE | FINE |
| | 86 | 1 | 100 | 85 | 185 | 90 | 90 | 82.5 | 1.39 | 37.3 | FINE | FINE |
| | 87 | 1 | 100 | 85 | 185 | 100 | 100 | 82.5 | 1.4 | 37.5 | FINE | FINE |
| | 88 | 1 | 90 | 90 | 180 | 60 | 60 | 77.5 | 2.22 | 34.6 | FAILED | FAILED |
| | 89 | 1 | 90 | 90 | 180 | 70 | 70 | 80 | 2.21 | 36.3 | FINE | FINE |
| | 90 | 1 | 90 | 90 | 180 | 80 | 80 | 82.5 | 2.52 | 37.3 | FINE | FINE |
| | 91 | 1 | 90 | 90 | 180 | 90 | 90 | 85 | 2.78 | 38.1 | FINE | FINE |
| | 92 | 1 | 90 | 90 | 180 | 100 | 100 | 85 | 3.08 | 37.9 | FINE | FINE |
| | 93 | 1 | 80 | 100 | 180 | 100 | 100 | 82.5 | 3.51 | 36.2 | FINE | FINE |
| | 94 | 1 | 80 | 100 | 180 | 90 | 90 | 80 | 3.41 | 35.8 | FINE | FINE |
| | 95 | 1 | 80 | 100 | 180 | 80 | 80 | 80 | 3.33 | 35.0 | FINE | FINE |
| | 96 | 1 | 80 | 100 | 180 | 70 | 70 | 77.5 | 3.33 | 34.3 | FAILED | FAILED |
| | 97 | 1 | 80 | 90 | 170 | 100 | 100 | 77.5 | 2.33 | 34.8 | FAILED | FAILED |

PHD = Preliminary Heating Device

[Table 6]

TABLE 6

| | | | Upper | Lower | | | | | | | | |
|---|---|---|---|---|---|---|---|---|---|---|---|---|
| | | Carrying | Roll | Roll | T1 + T2 | PHD 52 | PHD 50 | Work | Wrinkles | Adhesive | | |
| | | Speed | Temp. T2 | Temp. T1 | Total | Temp. | Temp. | Temp. T3 | Wca | Strength | | |
| | No. | (m/min) | (° C.) | (° C.) | (° C.) | (° C.) | (° C.) | (° C.) | (μm) | (N/m) | Transfer | Judgment |
| Effects by | 108 | 1 | 100 | 100 | 200 | 80 | 80 | 87.5 | 9.57 | 40.2 | FINE | FINE |
| increasing | 109 | 2 | 100 | 100 | 200 | 80 | 80 | 80 | 8.92 | 36.3 | FINE | FINE |
| transfer speed | 110 | 3 | 100 | 100 | 200 | 80 | 80 | 77.5 | 7.6 | 34.7 | FAILED | FAILED |
| Heating both | 111 | 4 | 100 | 100 | 200 | 80 | 80 | 72.5 | 6.71 | 32.0 | FAILED | FAILED |
| rollers + both | 112 | 1 | 100 | 100 | 200 | 100 | 100 | 92.5 | 9.77 | 41.0 | FINE | FINE |
| PHD | 113 | 2 | 100 | 100 | 200 | 100 | 100 | 87.5 | 8.21 | 38.7 | FINE | FINE |
| Example 7 | 114 | 3 | 100 | 100 | 200 | 100 | 100 | 82.5 | 7.8 | 37.3 | FINE | FINE |
| | 115 | 4 | 100 | 100 | 200 | 100 | 100 | 80 | 7.2 | 36.3 | FINE | FINE |

PHD = Preliminary Heating Device

1. A method of production of an electronic device having an internal electrode comprising steps of:
forming an electrode layer on a surface of a first support sheet;
forming an adhesion layer on a surface of a second support sheet;
forming said adhesion layer on a surface of said electrode layer by a transfer method;
pressing a green sheet to the surface of said electrode layer via said adhesion layer to adhere said electrode layer to a surface of said green sheet;
stacking green sheets, to which said electrode layer is adhered, to form a green chip; and
firing said green chip;
wherein, when transferring said adhesion layer to said electrode layer,
said first support sheet and said second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll; and
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
90≦T2≦135 and
190<T1+T2.

2. A method of production of an electronic device having an internal electrode comprising steps of:
forming an electrode layer on a surface of a first support sheet;
forming an adhesion layer on a surface of a second support sheet;
forming said adhesion layer on a surface of said electrode layer by a transfer method;
pressing a green sheet to the surface of said electrode layer via said adhesion layer to adhere said electrode layer to a surface of said green sheet;
stacking green sheets, to which said electrode layer is adhered, to form a green chip; and
firing said green chip;
wherein, when transferring said adhesion layer to said electrode layer,
said first support sheet and second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll;
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
80≦T2≦135 and
170<T1+T2; and,
said first support sheet and second support sheet are preliminarily heated at a temperature of 80° C. or higher respectively before said first support sheet and second support sheet are fed between said first and second transfer rolls.

3. A method of production of an electronic device having an internal electrode comprising steps of:
forming an electrode layer on a surface of a first support sheet;
forming an adhesion layer on a surface of a second support sheet;
forming said adhesion layer on a surface of said electrode layer by a transfer method;
pressing a green sheet to the surface of said electrode layer via said adhesion layer to adhere said electrode layer to a surface of said green sheet;
stacking green sheets, to which said electrode layer is adhered, to form a green chip; and
firing said green chip;
wherein
said first support sheet and second support sheet are fed between a first and second transfer rolls so that a rear surface of said first support sheet on which said electrode layer is formed makes contact with said first transfer roll and a rear surface of said second support sheet on which said adhesion layer is formed makes contact with said second transfer roll; and
any one of said first and second transfer rolls is heated while the other is not heated, in which the support sheet to be making contact with the other not-heated transfer roll is preliminarily heated at a temperature of 80° C. or higher before making contact with the transfer roll.

4. The method of production of an electronic device having an internal electrode as set forth in claim 2, wherein a preliminary heating temperature is 135° C. or lower.

5. The method of production of an electronic device having an internal electrode as set forth in claim 1, wherein
said first support sheet is linearly fed between said first and second transfer rolls; and
said second support sheet is fed between said first and second transfer rolls with a first predetermined angle θ1, and output with a second predetermined angle θ2, with respect to said first support sheet.

6. The method of production of an electronic device having an internal electrode as set forth in claim 1, wherein said electrode layer is formed on the surface of said first support sheet so as to have a peel strength of 10 to 60 mN/cm;
said adhesion layer is formed on the surface of said second support sheet so as to have a peel strength of 10 mN/cm or lower.

7. The method of production of an electronic device having an internal electrode as set forth in claim 1, wherein
said second transfer roll is comprised of metal, and
said first transfer roll is a roll lined with a rubber layer.

8. The method of production of an electronic device having an internal electrode as set forth in claim 1, wherein
a release layer is formed on the surface of said first support sheet, and
said electrode layer is formed on the release layer.

9. The method of production of an electronic device having an internal electrode as set forth in claim 8, wherein
a blank pattern layer having a thickness substantially same as that of said electrode layer is formed on the surface of said release layer on which said electrode layer is not formed.

10. A transfer machine comprising:
a pair of a first and second transfer rolls, between which a first support sheet and a second support sheet are fed so that a rear surface of said first support sheet on which an electrode layer is formed makes contact with said first transfer roll; a rear surface of said second support sheet on which an adhesion layer is formed makes contact with said second transfer roll; and said electrode layer and adhesion layer are bonded by pressure;
a first heating means to heat said first transfer roll at a first predetermined temperature T1 (° C.);
a second heating means to heat said second transfer roll at a second predetermined temperature T2 (° C.);
a first and second preliminary heating means to preliminarily heat said first support sheet and second support sheet respectively at a temperature of 80° C. or higher before said first support sheet and second support sheet are fed between said first and second transfer roll;
wherein said first predetermined temperature T1 and second predetermined temperature T2 satisfy:
60<T1<110,
80≦T2<135 and
170<T1+T2.

11. A transfer machine comprising:
a pair of a first and second transfer rolls, between which a first support sheet and a second support sheet are fed so that a rear surface of said first support sheet on which an electrode layer is formed makes contact with said first transfer roll; a rear surface of said second support sheet on which an adhesion layer is formed makes contact with said second transfer roll; and said electrode layer and adhesion layer are bonded by pressure;
a roll-heating means to heat any one of said first and second transfer rolls and not heat the other; and
a preliminary heating means to preliminarily heat the support sheet to be making contact with the other not-heated transfer roll at a temperature of 80° C. or higher before making contact with the transfer roll.

12. The transfer machine as set forth in claim 10, wherein
said first support sheet and second support sheet are fed between said first and second transfer rolls with a first predetermined angle of 10 to 70 degrees; and
said first support sheet and second support sheet are output between said first and second transfer rolls with a second predetermined angle of 10 to 70 degrees.

13. A method of production of an electronic device having an internal electrode comprising steps of:
forming an adhesion layer on a surface of an electrode layer formed on a surface of a first support sheet;
forming a green sheet on a surface of a second support sheet;
pressing the green sheet, formed on the surface of said second support sheet, to the surface of said electrode layer via said adhesion layer to adhere said green sheet to the surface of said electrode layer by transfer method;
stacking green sheets, to which said electrode layer is adhered, to form a green chip; and
firing said green chip;
wherein, when transferring said green sheet to said electrode layer, said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll; and
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
90≦T2<135 and
190<T1+T2.

14. A method of production of an electronic device having an internal electrode comprising steps of:
forming an adhesion layer on a surface of an electrode layer formed on a surface of a first support sheet;
forming a green sheet on a surface of a second support sheet;
pressing the green sheet, formed on the surface of said second support sheet, to the surface of said electrode layer via said adhesion layer to adhere said green sheet to the surface of said electrode layer by transfer method;
stacking green sheets, to which said electrode layer is adhered, to form a green chip; and
firing said green chip;
wherein, when transferring said green sheet to said electrode layer,
said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll;
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
80≦T2<135 and
170<T1+T2; and
said first support sheet and second support sheet are preliminarily heated at a temperature of 80° C. or higher respectively before said first support sheet and second support sheet are fed between said first and second transfer rolls.

15. A method of production of an electronic device having an internal electrode comprising steps of:
forming an adhesion layer on a surface of an electrode layer formed on a surface of a first support sheet;
forming a green sheet on a surface of a second support sheet;
pressing the green sheet, formed on the surface of said second support sheet, to the surface of said electrode layer via said adhesion layer to adhere said green sheet to the surface of said electrode layer by transfer method;
stacking green sheets, to which said electrode layer is adhered, to form a green chip; and
firing said green chip;
wherein, when transferring said green sheet to said electrode layer,
said first support sheet and second support sheet are fed between a first and second transfer rolls so that a rear surface of said first support sheet on which said electrode layer is formed makes contact with said first transfer roll and a rear surface of said second support sheet on which said green sheet is formed makes contact with said second transfer roll; and
any one of said first and second transfer rolls is heated while the other is not heated, in which the support sheet to be making contact with the other not-heated transfer roll is preliminarily heated at a temperature of 80° C. or higher before making contact with the transfer roll.

16. The method of production of an electronic device having an internal electrode as set forth in claim 1, wherein a preliminary heating temperature is 135° C. or lower.

17. The method of production of an electronic device having an internal electrode as set forth in claim 13, wherein
said first support sheet is linearly fed between said first and second transfer rolls; and
said second support sheet is fed between said first and second transfer rolls with a first predetermined angle θ1, and output with a second predetermined angle θ2, with respect to said first support sheet.

18. The method of production of an electronic device having an internal electrode as set forth in claim 13, wherein
said electrode layer is formed on the surface of said first support sheet so as to have a peel strength of 10 to 60 mN/cm;
said green sheet is formed on the surface of said second support sheet so as to have a peel strength of 10 mN/cm or lower.

19. The method of production of an electronic device having an internal electrode as set forth in claim 13, wherein
said second transfer roll is comprised of metal, and
said first transfer roll is a roll lined with a rubber layer.

20. The method of production of an electronic device having an internal electrode as set forth in claim 13, wherein
a release layer is formed on the surface of said first support sheet, and
said electrode layer is formed on the release layer.

21. The method of production of an electronic device having an internal electrode as set forth in claim 20, wherein
a blank pattern layer having a thickness substantially same as that of said electrode layer is formed on the surface of said release layer on which said electrode layer is not formed.

22. A transfer machine comprising:
a pair of a first and second transfer rolls, between which a first support sheet and a second support sheet are fed so that a rear surface of said first support sheet on which an electrode layer is formed makes contact with said first transfer roll; a rear surface of said second support sheet on which a green sheet is formed makes contact with said second transfer roll; and said electrode layer and green sheet are bonded by pressure;
a first heating means to heat said first transfer roll at a first predetermined temperature T1 (° C.);
a second heating means to heat said second transfer roll at a second predetermined temperature T2 (° C.);
a first and second preliminary heating means to preliminarily heat said first support sheet and second support sheet respectively at a temperature of 80° C. or higher before said first support sheet and second support sheet are fed between said first and second transfer roll;
wherein said first predetermined temperature T1 and second predetermined temperature T2 satisfy:
60<T1<110,
80≦T2<135 and
170<T1+T2.

23. A transfer machine comprising:
a pair of a first and second transfer rolls, between which a first support sheet and a second support sheet are fed so that a rear surface of said first support sheet on which an electrode layer is formed makes contact with said first transfer roll; a rear surface of said second support sheet on which a green sheet is formed makes contact with said second transfer roll; and said electrode layer and green sheet are bonded by pressure;
a roll-heating means to heat any one of said first and second transfer rolls and not heat the other; and
a preliminary heating means to preliminarily heat the support sheet to be making contact with the other not-heated transfer roll at a temperature of 80° C. or higher before making contact with the transfer roll.

24. The transfer machine as set forth in claim 22, wherein
said first support sheet and second support sheet are fed between said first and second transfer rolls with a first predetermined angle of 10 to 70 degrees; and
said first support sheet and second support sheet are output between said first and second transfer rolls with a second predetermined angle of 10 to 70 degrees.

25. A method of production of an electronic device having an internal electrode comprising steps of:
forming a green sheet on a surface of an electrode layer formed on a surface of a first support sheet;
forming an adhesion layer on a surface of a second support sheet;
pressing the adhesion layer, formed on the surface of said second support sheet, to the surface of said green sheet to transfer said adhesion layer to the surface of said green sheet by transfer method;
stacking green sheets, on which said internal electrode layer is formed, to form a green chip; and
firing said green chip;
wherein, when transferring said adhesion layer to said green sheet,
said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll; and
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
90≦T2<135 and
190<T1+T2.

26. A method of production of an electronic device having an internal electrode comprising steps of:
forming a green sheet on a surface of an electrode layer formed on a surface of a first support sheet;
forming an adhesion layer on a surface of a second support sheet;
pressing said adhesion layer to the surface of said green sheet to transfer said adhesion layer to the surface of said green sheet;
stacking green sheets, to which said electrode layer is adhered, to form a green chip; and
firing said green chip;
wherein, when transferring said adhesion layer to said green sheet, said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll;
said first transfer roll is heated at a first predetermined temperature T1 (° C.) and said second transfer roll is heated at a second predetermined temperature T2 (° C.), in which said first predetermined temperature T1 and second predetermined temperature T2 satisfy:
60<T1<110,
80≦T2<135 and
170<T1+T2; and
said first support sheet and second support sheet are preliminarily heated at a temperature of 80° C. or higher, preferably 80 to 100° C., respectively before said first support sheet and second support sheet are fed between said first and second transfer rolls.

27. A method of production of an electronic device having an internal electrode comprising steps of:
forming a green sheet on a surface of an electrode layer formed on a surface of a first support sheet;
forming an adhesion layer on a surface of a second support sheet;
pressing said adhesion layer to the surface of said green sheet to transfer said adhesion layer to the surface of said green sheet;
stacking green sheets, to which said electrode layer is adhered, to form a green chip; and
firing said green chip;
wherein, when transferring said adhesion layer to said green sheet,
said first support sheet and second support sheet are fed between a first and second transfer rolls so that a rear surface of said first support sheet on which said green sheet is formed makes contact with said first transfer roll and a rear surface of said second support sheet on which said adhesion layer is formed makes contact with said second transfer roll; and
any one of said first and second transfer rolls is heated while the other is not heated, in which the support sheet to be making contact with the other not-heated transfer roll is preliminarily heated at a temperature of 80° C. or higher before making contact with the transfer roll.

28. The method of production of an electronic device having an internal electrode as set forth in claim 26, wherein a preliminary heating temperature is 135° C. or lower.

29. The method of production of an electronic device having an internal electrode as set forth in claim 25, wherein
said first support sheet is linearly fed between said first and second transfer rolls; and
said second support sheet is fed between said first and second transfer rolls with a first predetermined angle θ1, and output with a second predetermined angle θ2, with respect to said first support sheet.

30. The method of production of an electronic device having an internal electrode as set forth in claim 25, wherein
said electrode layer is formed on the surface of said first support sheet so as to have a peel strength of 10 to 60 mN/cm;
said green sheet is formed on the surface of said second support sheet so as to have a peel strength of 10 mN/cm or lower.

31. The method of production of an electronic device having an internal electrode as set forth in claim 25, wherein
said second transfer roll is comprised of metal, and
said first transfer roll is a roll lined with a rubber layer.

32. The method of production of an electronic device having an internal electrode as set forth in claim 25, wherein
a release layer is formed on the surface of said first support sheet and
said electrode layer is formed on the release layer.

33. The method of production of an electronic device having an internal electrode as set forth in claim 32, wherein
a blank pattern layer having a thickness substantially same as that of said electrode layer is formed on the surface of said release layer on which said electrode layer is not formed.
